(19) United States
(12) Patent Application Publication
(10) Pub. No.: US 2013/0072626 A1
(43) Pub. Date: Mar. 21, 2013

(54) Fiber-Reinforced, Thermoplastic Tape as a Strength Member for Wire and Cable

(71) Applicant: Buo Chen, Hillsborough, NJ (US)

(72) Inventor: Buo Chen, Hillsborough, NJ (US)

(21) Appl. No.: 13/698,880

(22) PCT Filed: May 24, 2011
(86) PCT No.: PCT/US2011/037643

§ 371 Date: Nov. 19, 2012

Related U.S. Application Data
(60) Provisional application No. 61/352,618, filed on Jun. 8, 2010.

(51) Int. Cl. G02B 6/44; C08K 7/14; B29C 47/00; C08L 23/12

(52) U.S. Cl. CPC G02B 6/4401; C08L 23/12; C08K 7/14; B29C 47/0004
USPC 524/584; 385/100; 264/109; 264/119

(57) ABSTRACT

Fiber reinforced tape comprises a longitudinal axis, at least 30 percent by weight of a fiber and at least 2 percent by weight of a thermoplastic resin, with the proviso that at least 30 percent of the fibers in the tape are at least partially oriented along the longitudinal axis of the tape. The tape is useful as a strength member for wire and cable constructions, particularly fiber optic cable constructions.

### BACKGROUND OF THE INVENTION

1. Field of the Invention

This invention relates to wire and cable. In one aspect the invention relates to a strength member of a wire or cable while in another aspect, the invention relates to a strength member that is in the form of a fiber reinforced tape. In still another aspect the invention relates to a process for making a strength member in the form of a fiber-reinforced tape while yet in another aspect, the invention relates to wire and cable comprising a fiber reinforced tape strength member.

2. Description of the Related Art

Fiber-optic cable is a complex structure designed to provide sufficient protection for the optical fibers from detrimental levels of longitudinal and transverse stresses. In addition, the structure also provides a benign chemical and physical environment for the service life of the optical fibers. One fundamental difference between fiber-optic cable and electrical power cable is that the metal conductors in a power cable carry at least portion of the tensile stresses created during installation and in-service conditions. In contrast, fiber-optic cables contain strength members integrated into the cable specifically to isolate the fibers from tensile and compressive stresses. Sufficient tensile and compressive strength, ability to withstand small radius bends, easy fiber handling and cable installation, and competitive cost are just a few of the criteria among the many that must be considered when designing a fiber-optic cable and its component parts, including the strength member.

Many types of designs are available for fiber-optic cables, the design of choice dependent upon the application. Whatever the choice, all require some type of strength member to carry the tensile and compressive stresses of the cable during both installation and in-service use.

The strength members in use today are made mainly of fiber reinforced plastic (FRP), which is also known as glass reinforced plastic (GRP) if glass fiber is the reinforcement), or stainless steel. Traditionally, FRP or GRP is manufactured through a fiber pultrusion process using one or more thermoset resins such as vinyl ester or epoxy, but the speed of process is very limited. In addition, the GRP or FRP/thermoset resin composites available today tend to have excessive stiffness, and this makes installation of fiber optic cable comprising these strength members difficult, especially around buildings or along busy city streets where sharp bending of the cable is often necessary. As for stainless steel and loose aramid yarns, the former is relatively expensive and heavy while the latter is difficult to handle during the manufacturing process and they take a lot space within the cable.

Long-fiber, reinforced thermoplastic (LFT) technology is used in the automotive industry for making front panels through an injection molding process, and LFT materials in strip or pellet form are widely available in the market with various fibers and resin systems. They are also custom manufactured to specific specifications.

### SUMMARY OF THE INVENTION

In one embodiment the invention is a strength member in the form of a fiber-reinforced thermoplastic tape. In one embodiment the tape comprises fiber bundles made using LFT material that have been processed through an extruder that imparts at least a partial machine-direction orientation to the fibers which in turn imparts to the tape a modulus four times larger or more than the modulus of the thermoplastic resin itself. The tape is useful as a strength member in optic fiber cables and other wire and cable applications.

In one embodiment the invention is a fiber reinforced tape having a longitudinal axis, the tape comprising at least 30 percent by weight of a fiber and at least 2 percent by weight of a thermoplastic resin with the proviso that at least 30 percent of the fibers in the tape are at least partially oriented along the longitudinal axis of the tape.

In one embodiment the invention is a process of making a fiber reinforced thermoplastic tape, the process comprising the steps of (A) preparing long fiber thermoplastic pellets or strips comprising at least 30 percent fiber and at least 2 weight percent thermoplastic resin, (B) forming an extrudable mass from the pellets or strips, and (C) extruding the mass to form a tape with machine and cross direction dimensions with the proviso that at least 30 percent of the fibers are oriented in the machine direction.

In one embodiment the invention is a wire or cable construction comprising a fiber reinforced tape in which the tape comprises at least 30 percent by weight of a fiber and at least 2 percent by weight of a thermoplastic resin with the proviso that at least 30 percent of the fibers in the tape are at least partially oriented along the longitudinal axis of the tape. In one embodiment the invention is a fiber optic cable comprising the fiber reinforced tape.

The invention leverages the high fiber content and long fiber length in the LFT materials. Under the design of this invention, LFT strips (e.g., 4-12 millimeters (mm) in length) with various fiber loadings by weight are processed through an extruder using a pre-determined temperature profile and die design to produce composite fiber bundles in the form of thin tapes, e.g., thickness typically less than 2 mm. Drawing of 25% or more may be achieved once the material exits the die through control of the tape winding speed. The drawing helps orient the fibers along the machine direction in the composite. Because of the high fiber loading and the orientation, the tensile modulus of the LFT composite tape along the machine direction may exceed four times of the modulus of the resin alone. This high modulus feature qualifies the composite tape as strength member in a fiber optic cable, which can help reduce the thickness of the jacket or other protective layers in the cable. This tape can also replace aramid yarn in the fiber optic cable which is expensive and difficult to process.

Using the LFT fiber bundle tape as a strength member in a wire and cable application, particularly a fiber optic cable, one or more of the following advantages can be obtained over the use of conventional strength members in the wire or cable:
A. Light weight,
B. Better manufacturing efficiency due to the use of extrusion technology as opposed to fiber pultrusion technology,
C. More compact cable because the tape can wrap around the fiber optic bundle more tightly than loose aramid yarn,
D. Additional crush resistance,
E. Recyclability,
F. Water blocking by incorporating water blockers into the formulation, and
G. Crosslinkability.
   The fiber reinforced tapes of this invention are effective strength members for wire and cable applications, and they are viable replacements for the current FRP/GRP or aramid strength members in fiber optic cable.

### BRIEF DESCRIPTION OF THE DRAWINGS

FIG. 1 is a schematic illustration of a temperature and pressure profile of twin-screw extruder for manufacturing a composite tape of this invention.

FIG. 2 is an illustration of a composite tape of this invention extruded with 60 weight percent fiber loadings.

FIG. 3 is a graph reporting a comparison of the modulus of extruded and molded composites and neat resin.

FIG. 4 is a graph reporting a comparison of peak stresses of extruded and molded samples.

### DETAILED DESCRIPTION OF THE PREFERRED EMBODIMENT

### Definitions

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, thickness, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the component amounts of formulations, thickness, etc.

“Filament” and like terms mean a single, continuous strand of elongated material having a length to diameter ratio of greater than 10.

“Fiber” and like terms mean an elongated column of entangled filament having a generally round cross-section and a length to diameter ratio greater than 10.

Cable” and like terms mean at least one wire or optical fiber within a protective jacket or sheath. Typically, a cable is two or more wires or optical fibers bound together, typically in a common protective jacket or sheath. The individual wires or fibers inside the jacket may be bare, covered or insulated. Combination cables may contain both electrical wires and optical fibers. The cable, etc., can be designed for low, medium and high voltage applications. Typical cable designs are illustrated in U.S. Pat. Nos. 5,246,783, 6,496,629 and 6,714,707.

“Tape” and like terms mean a thin strip of material of indefinite length. Typically the length of the strip of material is at least ten (10) times larger than its width or thickness.

“At least a partial machine-direction orientation” and like terms mean that a percentage, typically at least 30 percent, of fibers in a thermoplastic tape that has machine and cross directions are positioned within the tape such that the length dimension of the fiber has a greater alignment with the machine direction of the tape than it has with the cross direction of the tape.

“Machine direction” and like terms mean the direction parallel to the forward movement of material through an extruder. For extruded material machine direction and longitudinal axis have the same meaning.

“Cross direction” and like terms mean the direction normal or perpendicular to the machine direction.

Fiber

Various kinds of fiber can be used in the practice of this invention including, but not limited to, polyolefin, e.g., polyethylene and polypropylene fiber, nylon fiber, polyester fiber, glass fiber, graphite fiber, quartz fiber, metal fiber, ceramic fiber, boron fiber, aluminum fiber, and combinations of two or more of these or other fibers. Fiber is typically available as yarn or roving which is a bundle of individual filaments on a spool. The denier of the fiber can vary to the composition of the fiber and the application to which the fiber bundle is placed, but typically it is between 400 and 5,000TEX, more typically between 600 and 3,000TEX, and even more typically between 700 and 2,500TEX.

Representative polyolefin fibers include SPECTRA® 900 polyethylene fiber from Honeywell, DOW XLA™ polyolefin fibers, and TOHO TENAX BESFIGHT® G30-700 carbon fibers. Representative glass fibers include Owens Corning's E-glass fibers OC® SE 4121 (1200 or 2400 tex), and John Manville JM 473AT (2400 tex), 473A (2400 and 1200 tex), PPG 4599 (2400 tex). OC® SE 4121 is an advanced member of the Single-End Continuous Rovings (Type 30) family. This product is specially designed for use in polypropylene long-fiber thermoplastic (LFT) applications. OC SE 4121 has a chemistry that is designed to be suitable with Direct-LFT processes.

Glass fibers: Manville JM 473AT (1100, 1200, or 2400 tex) or similar grade of fibers from other suppliers may be used. Manville JM 473AT is a STARROV® LFTplus direct roving fiber and is manufactured by direct winding of continuous glass fibers of defined diameter into a cylindrical roving package. This roving is designed for reinforcement of polypropylene polymers in the LFT processes. The selected material properties and fiber characteristics are list in Table 1.

TABLE 1
Selected Properties of Manville JM 473AT E-Glass Fiber

| | | | | | Moisture | | |
|---|---|---|---|---|---|---|---|
| | | | | LOI | content | Linear | Filament |
| JM | | Glass | Sizing | content | maximum | density | diameter |
| designation | Region | type | designation | [%] | [%] | [yield/tex] | [μm] |
| PR 220 1100 473A | EU | E | 473A | 0.60 | 0.15 | 450/1100 | 15.5 |
| PR 220 1200 473A | EU | E | 473A | 0.60 | 0.15 | 413/1200 | 16 |
| PR 440 2400 473A | EU | E | 473A | 0.70 | 0.15 | 207/2400 | 16 |

The amount of fiber in the fiber bundle is typically at least 20, more typically at least 60 and even more typically at least 80, weight percent (wt %) based on the weight of the bundle. The maximum amount of fiber in the fiber bundle typically does not exceed 98, more typically does not exceed 95 and even more typically does not exceed 90, wt % based on the weight of the bundle.

Resin

Various kinds of commercially available thermoplastic resins can be used in the manufacture of the fiber reinforced bundles used to make the fiber reinforced tapes of this invention including, but not limited to, those resins commonly known and used for forming fiber-reinforced polymeric plastic. Typical thermoplastic resins include, but are not limited to, acrylic resin, acrylate resin, epoxy resin, carbonate resin, polyolefin resin and combinations of two or more of these and/or other resins.

The polyolefin resins useful in the practice of this invention are thermoplastic, and include both polyolefin homopolymers and interpolymers. Examples of polyolefin homopolymers are the homopolymers of ethylene and propylene. Examples of the polyolefin interpolymers are the ethylene/α-olefin interpolymers and the propylene/α-olefin interpolymers. The α-olefin is preferably a C₃₋₂₀ linear, branched or cyclic α-olefin (for the propylene/α-olefin interpolymers, ethylene is considered an α-olefin). Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this invention certain cyclic olefins, such as norbornene and related olefins, are α-olefins and can be used in place of some or all of the α-olefins described above. Similarly, styrene and its related olefins (for example, α-methylstyrene, etc.) are α-olefins for purposes of this invention. Illustrative polyolefin copolymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, and ethylene/butene/styrene. The copolymers can be random or blocky.

The polyolefin resins can also comprise one or more functional groups such as an unsaturated ester or acid, and these polyolefins are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 1 up to 50 percent by weight based on the weight of the copolymer. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids or maleic acids.

Functional groups can also be included in the polyolefin through grafting which can be accomplished as is commonly known in the art. In one embodiment, grafting may occur by way of free radical functionalization which typically includes melt blending an olefin polymer, a free radical initiator (such as a peroxide or the like), and a compound containing a functional group. During melt blending, the free radical initiator reacts (reactive melt blending) with the olefin polymer to form polymer radicals. The compound containing a functional group bonds to the backbone of the polymer radicals to form a functionalized polymer. Exemplary compounds containing functional groups include but are not limited to alkoxysilanes, e.g., vinyl trimethoxysilane, vinyl triethoxysilane, and vinyl carboxylic acids and anhydrides, e.g., maleic anhydride.

More specific examples of polyolefins useful in this invention include very low density polyethylene (VLDPE) (e.g., FLEXOMER® ethylene/1-hexene polyethylene made by The Dow Chemical Company), homogeneously branched, linear ethylene/α-olefin copolymers (e.g. TAFMER® by Mitsui Petrochemicals Company Limited and EXACT® by Exxon Chemical Company), homogeneously branched, substantially linear ethylene/α-olefin polymers (e.g., AFFINITY® and ENGAGE® polyethylene available from The Dow Chemical. Company), and olefin block copolymers such as those described in U.S. Pat. No. 7,355,089 (e.g., INFUSE® available from The Dow Chemical Company). The more preferred polyolefin copolymers are the homogeneously branched linear and substantially linear ethylene copolymers. The substantially linear ethylene copolymers are especially preferred, and are more fully described in U.S. Pat. Nos. 5,272,236, 5,278,272 and 5,986,028.

The polyolefins useful in the practice of this invention also include propylene, butene and other alkene-based copolymers, e.g., copolymers comprising a majority of units derived from propylene and a minority of units derived from another α-olefin (including ethylene). Exemplary propylene polymers useful in the practice of this invention include the VERSIFY® polymers available from The Dow Chemical Company, and the VISTAMAXX® polymers available from ExxonMobil Chemical Company.

Blends of any of the above olefinic elastomers can also be used in this invention, and the olefin elastomers can be blended or diluted with one or more other polymers to the extent that, in a preferred mode, the olefin elastomers of this invention constitute at least about 50, preferably at least about 75 and more preferably at least about 80, weight percent of the thermoplastic polymer component of the blend and retain their flexibility. In a less preferred mode and depending on other properties that may be sought, the olefin elastomer content may be less than 50% of the thermoplastic polymer component. In one embodiment the impregnating resin is INSPIRE® 404 or DOW® H734-52RNA performance polymer (polypropylene) both available from The Dow Chemical Company, or similar grades of polypropylene resin available from other suppliers.

The resins used in the practice of this invention can include one or more additive to facilitate their processing and/or use. Typical additives include compatibility/coupling agents, e.g., FUSABOND® P353 by DuPont or OREVAC® CA 100 by Arkema or POLYBOND® 3200 by Chemtura; flow promoters, e.g., Borealis BORFLOW® 405 or 805 or Dow AFFINITY® GA 1950; pigment, e.g., Hubron Black Masterbatch PPB or Cabot PLASBLAK® 4045; and antioxidants, e.g., IRGANOX® 1010, IRGAFOS® 168 and/or IRGANOX® PS 802 (as supplied by Ciba Specialty Chemicals). These and other additives are used in conventional amounts and in conventional ways.

The amount of resin (including any additives and/or fillers) in the fiber bundle is typically at least 2, more typically at least 5 and even more typically at least 10, weight percent (wt %) based on the weight of the bundle. The maximum amount of resin in the fiber bundle typically does not exceed 80, more typically does not exceed 60 and even more typically does not exceed 40, wt % based on the weight of the bundle.

Method of Making the Fiber Bundle

The fiber bundles, i.e., the LFT material, can be made by any convenient process including, but not limited to, passing fiber (including but not limited to glass fibers) through a pultrusion process to impregnate the fibers with a thermoplastic resin as described above. The specifics of pultrusion processing are well known to those of ordinary skill in the art, and are generally described in U.S. Pat. No. 7,507,361. The material is then chopped into pellets or strips. Usually these LFT strips contain fibers ranging from 3 to 15 mm in length, more typically from 5 to 12 mm in length, with a weight ratio from 30% to 95%, more typically from 50% to 85%.

Method of Making the Tape

The tapes of this invention are made using an extrusion process. Typically a twin screw extruder is chosen, but single screw extruders can also be used. The screws typically turn at 10-200, more typically 15 to 150 and even more typically 20 to 100, revolutions per minute (rpm). Since the fibers are already mixed in the strips/pellets, no mixing is required. The extruder screws are set with a compression ratio larger than 2.5:1 without the use of mixing elements. The chamber temperatures are set at 180-220° C. for the different zones in the extruder, and the die temperature (e.g., 180-230° C.) is typically the highest among all zones. The extrusion speed is typically 0.2 to 5 m/min depending on the fiber loading of the end product. The tape can be collected as it leaves the extruder by using a winding spool or similar device. The winding unit can operate at a greater speed than that at which the extruder is operated, e.g., 10, 15, 25% or faster, to draw the material slightly and thus imparting or enhancing a machine direction orientation to the fibers. The tape dimensions typically are in the range of 1 to 50, more typically 2 to 25 and even more typically 5 to 12, mm in width, 0.1 to 2, more typically 0.2 to 1.5 and even more typically 0.5 to 1.2, mm in thickness, and of indefinite length.

Wire or Cable with Tape Strength Member

To serve as a strength member for a wire or cable application, particularly for a fiber optic cable, the tape typically has a modulus of at least 12 kilograms per square inch (kg/in²) or 5 GigaPascals (GPa), but a value of 6 to 10 GPa is more typical for this tape configuration. High modulus is a function of fiber loadings and adhesion between the fiber and resin matrix. Moreover, typically at least 30, more typically at least 40 and even more typically at least 50, percent of the total fiber loading in the tape is oriented in the machine direction (longitudinally). This orientation is a result of both extrusion through the die and/or drawing upon extrusion, e.g., from the winding unit.

The tape can be incorporated into the wire or cable construction in any suitable manner including, but not limited to, a longitudinal and/or traverse wrap around one or more wires or fibers within the construction. Alternatively, the tape can be incorporated into another component of the wire or cable construction, e.g., an insulation sheath or protective jacket. The tape may also be used as a stand alone strength component of the cable.

The invention is described more fully through the following examples. Unless otherwise noted, all parts and percentages are by weight.

### SPECIFIC EMBODIMENTS

### Materials

The fiber is Johns Manville JM 473AT (2400 tex), 473A glass fiber. The glass type of the fiber is E with an LOI content (%) of 0.70, a maximum moisture content of 0.15%, a linear density (yield/tex) of 207/2400, and a filament diameter of 16 microns. The fiber comprised 60 wt % of the composite.

The resin is DOW H734-52RNA, a polypropylene available from The Dow Chemical Company and with the properties reported in Table 2.

TABLE 2
Selected Properties of DOW H734-52RNA

| TEST ITEM AND | | | |
|---|---|---|---|
| CONDITION | LIMIT | UNIT | METHOD |
| MFR, 230 C/2.16 kg | 47.0-57.0 | dg/min | ISO 1133 |
| MFR Start Base, 230 C/2.16 kg | 31.0-34.0 | dg/min | ISO 1133 |
| MFR Mixing, 230 C/2.16 kg | 45.0-59.0 | dg/min | ISO 1133 |
| Xylene Solubles, spheres | 1.8-4.5 | % | ASTM D5492 |
| Pellet Yellowness | 1 Max | | ASTM D6290 |
| Flexural Modulus, 23 C | 1600 Min | MPa | ISO 178 |

The resin comprised 32.4 wt % of the composite.

The flow promoter is BORFLOW® HL504FB, a polypropylene homopolymer grade for fiber applications and available from Borealis. The flow promoter comprises 4 wt % of the composite.

The coupling agent is OREVAC® CA 100, a maleic anhydride modified polypropylene available from Arkema. The coupling agent comprises 1.5 wt % of the composite.

The pigment is PLASBAK® 4045, a black polypropylene masterbatch available from Cabot. The carrier is polypropylene homopolymer and the masterbatch contains 40 wt % carbon black. The pigment comprises 1.75 wt % of composite.

The antioxidants are IRGANOX 1010 (tetrakis-(methylene-(3,5-di-(tert)-butyl-4-hydrocinnamate))methane); IRGAFOS 168 (tris(2,4-di-tert-butylphenyl)phosphite); and IRGANOX PS 802 (dioctadecyl-3,3′-thiodipropionate), all available from Ciba.

LFT Process

LFT strips and pellets are produced by FACT of Germany using a conventional pultrusion process that employs an extruder of 20 horsepower and 4 heating zones. The extruder is equipped with a single screw of 3:1 Compression ratio with a length/diameter ratio of 25. Mixing elements are not used. The temperature profile of the extruder is: Zone 1-185° C., Zone 2-190° C., Zone 3-210° C., and a die temperature of 220° C. The extruder is operated at 65 rpm).

Extrusion Process

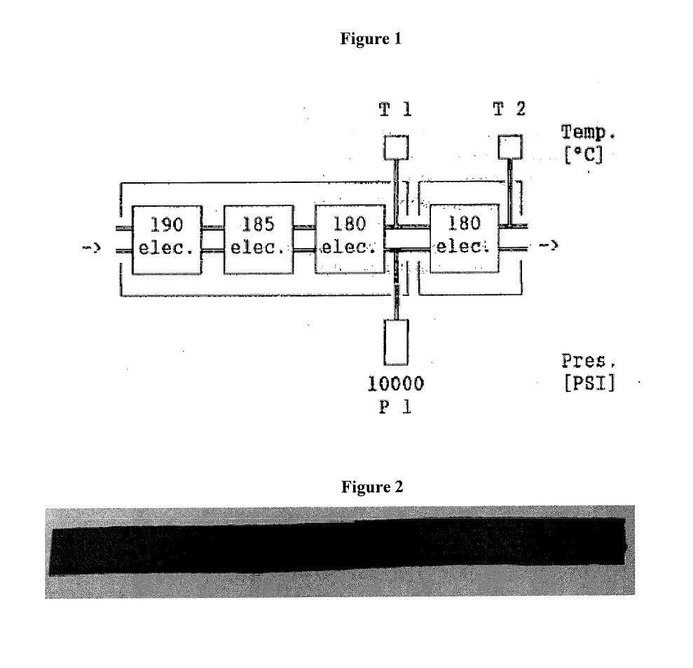

Brabender PL type 2000-3 twin screw extruder is used for the extrusion. FIG. 1 shows the temperature and pressure settings used for the different zones in the extruder. The temperature profile is “reversed” in that the highest temperature is in the first zone and the lowest temperature is in the last zone. This is to enable rapid melting of the resin matrix and reduce the amount of stress to which it is exposed. The pellets/strips are fed through the main hopper, and the screw speed is set at 30 rpm. A one-inch wide ribbon die is used to extrude the composite tape, and the tape is not stretched during the extrusion process before it is wound onto a spool.

FIG. 2 shows the samples made during the extrusion trial. A visual observation reveals that in both samples the fibers are able to retain their length in the composite, and they are slightly oriented in the machine direction. For this application slight fiber orientation in the machine direction is preferred to achieve higher tensile strength in that particular direction. Depending on how the tape is applied in the cable, however, sometimes complete random orientation may be actually preferred. In the example below, the level of fiber orientation attained is sufficient.

Testing and Results

For comparison purposes a Brabender batch mixer is also used to re-melt and mix the original LFT pellets. Plaques (0.03″ thick) are then compression molded in a hot press at the platen temperature of 190° C. Tensile samples are then prepared.

Tensile testing process is conducted on both extruded and molded samples following the wire and cable testing procedure of ASTM D638-03: Standard Test Method for Tensile Properties of Plastics (Details see 2008 Annual Book of ASTM Standards, Section 8, volume 08.01, ASTM International, West Conshohocken, Pa., 2008).

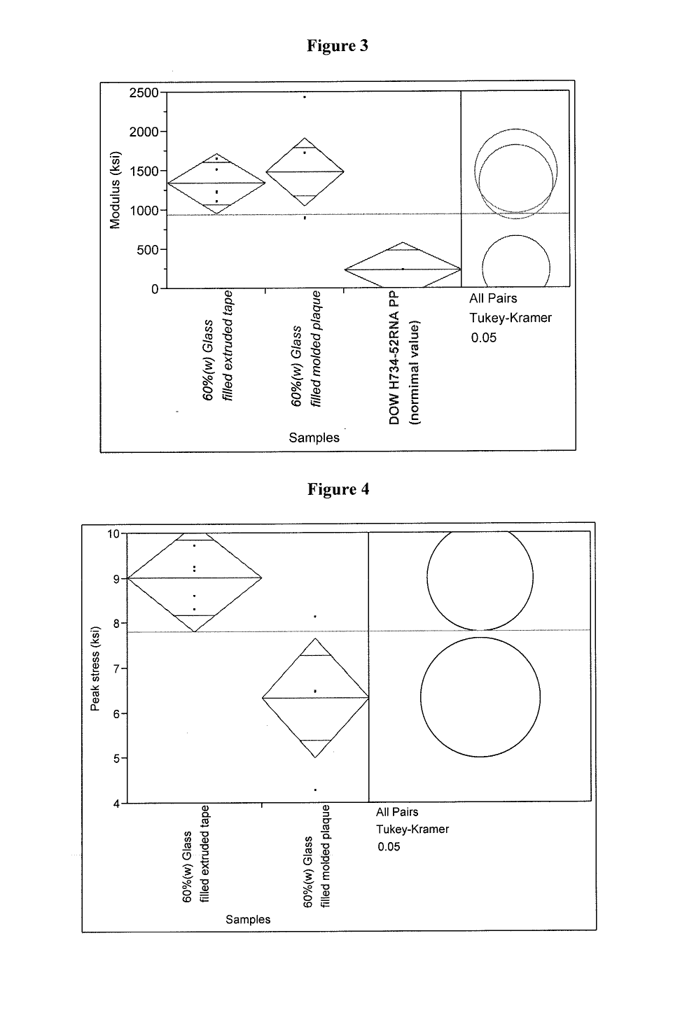

FIG. 3 shows the comparison of modulus of LFT extruded and molded samples versus neat polypropylene resin. The Tukey-Kramer analysis shows that the moduli of LFT extruded and molded are statistically higher compared to that of neat polypropylene (with mean values more than four times higher). The enhancement in modulus suggests that a significant reinforcing effect is achieved by adding long glass fibers in the composite. FIG. 4 shows the comparison of peak stress for each of composite samples, which indicates the fiber orientation. The Tukey-Kramer analysis shows that the extruded samples exhibit statistically higher peak stresses than the molded samples, suggesting a better fiber orientation in the extruded sample.

### CONCLUSIONS

The testing results show a significant improvement of modulus for the extruded LFT tape as compared to neat polypropylene resin. The LFT composite also exhibits a high peak stress. Combining both the high modulus and high stress to failure features demonstrates that the LFT composite tape is useful as a strength member in fiber-optic cable applications.

Table 2 reports the load carrying capacity of the composite tape in comparison with a conventional 1.5 mm diameter FRP that is used today in 5 mm fiber optic cable. Assuming that the cable is pulled at 1% of strain (which is typically the upper limit for strain without breaking the fiber optics), Table 2 shows that a 0.55 mm thick composite tape wrapping around a 5 mm diameter cable essentially has the same amount of load carrying capacity as a 1.5 mm diameter FRP (even though the modulus is lower). This load carrying capacity allows the cable to endure the handling stresses experienced during installation.

TABLE 3
Comparison of Load Carrying Capacity of Conventional FRP
and the Inventive Composite Tape

| | Modulus | Load Carring Capacity |
|---|---|---|
| FRP Compared with Composite Tape | (GPa) | at 1% Strain (N) |
| Glass Fiber FRP 1.5 mm Diameter | 49 | 865.46 |
| Composite Tape of 0.55 mm | 10.34 | 892.86 |
| Thickness Wrapping Around a | | |
| 5 mm Diameter Cable | | |

Although the invention has been described with certain detail through the preceding description of the preferred embodiments, this detail is for the primary purpose of illustration. Many variations and modifications can be made by one skilled in the art without departing from the spirit and scope of the invention as described in the following claims.

1. An extruded fiber reinforced tape having a longitudinal axis, the tape comprising at least 60 percent by weight of glass fibers with a linear density of 400 to 5,000TEX and at least 2 percent by weight of a thermoplastic resin with the proviso that at least 30 percent of the fibers in the tape are at least partially oriented along the longitudinal axis of the tape.

2. The tape of claim 1 in which the fibers are glass fibers with a linear density of 600 to 3,000TEX.

3. The tape of claim 2 in which the resin is a polyolefin resin.

4. The tape of claim 3 in which the resin is a polypropylene resin.

5. The tape of claim 4 in which the fibers have a length of 4 to 15 mm.

6. A process of making the tape of claim 1, the process comprising the steps of
(A) preparing long fiber thermoplastic pellets or strips comprising at least 60 weight percent glass fibers with a linear density of 400 to 5,000TEX and at least 2 weight percent thermoplastic resin,
(B) forming an extrudable mass from the pellets or strips, and
(C) extruding the mass to form a tape with machine and cross direction orientation with the proviso that at least 30 percent of the fibers are oriented in the machine direction.

7. The process of claim 6 in which the extrusion is preformed with an extruder equipped with a die operated at a temperature of 180-230° C.

8. The process of claim 7 in which the extruded tape is subjected to drawing.

9. A wire or cable construction comprising the tape of claim 1 as a strength member.

10. The wire or cable of claim 9 in the form of an optical fiber cable.
